(19) United States
(12) Patent Application Publication
(10) Pub. No.: US 2006/0115234 A1
(43) Pub. Date: Jun. 1, 2006

(54) Moving picture compression-encoding apparatus and storage method

(75) Inventors: Jae-hyun Kim, Suwon-si (KR); Yong-je Kim, Yongin--si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/206,092

(22) Filed: Aug. 18, 2005

(30) Foreign Application Priority Data
Sep. 30, 2004 (KR) 2004-77725

(51) Int. Cl. H04N 5/91

(52) U.S. Cl. 386/68; 386/69

(57) ABSTRACT

A moving picture compression-encoding apparatus and a moving picture storage method of compression-encoding and storing predetermined video frames necessary to replay a moving picture at the time of receiving a recording stop or pause signal during recording. At the time of receiving the recording stop or pause signal, encoding and storing are performed on all the video frames (including the last video frame) of a group of pictures (GOP) to which the currently-encoded video frame belongs; encoding and storing are performed on at least one I video frame in the next GOP in addition to all the video frames of the current GOP to which the currently-encoded video frame belongs; encoding and storing are performed on video frames of the current GOP necessary to replay the currently-encoded video frame; and/or encoding and storing are performed on an earlier I or P video frame prior to the currently-input video frame.

### CROSS-REFERENCE TO RELATED APPLICATION

This application claims the benefit of Korean Patent Application No. 10-2004-0077725, filed Sep. 30, 2004, in the Korean Intellectual Property Office, the disclosure of which is incorporated herein by reference.

### BACKGROUND OF THE INVENTION

1. Field of the Invention

The present invention relates generally to a moving picture compression-encoding apparatus and a moving picture storage method. More particularly, embodiments of the present invention relate to a moving picture compression-encoding apparatus and a moving picture storage method of compression-encoding and storing predetermined video frames necessary to replay a moving picture at the time of receiving a recording stop or pause signal during recording.

2. Description of the Related Art

In general, moving pictures have a large amount of data. The moving picture can be compressed by using relationships between video frames constituting the moving picture without reducing image quality of the moving picture. Compression schemes for moving pictures include the H.263 standard adapted to video conferencing, the MPEG-1 standard adapted to VCD, and the MPEG-2 standard adapted to DVD. Recently, the MPEG-4 and H.264 standards have been rapidly accepted.

Recently, there have been developed and commercialized moving picture compression-encoding apparatuses for compressing high-image-quality moving pictures in accordance with the aforementioned compression schemes to store the compressed data in various recording media such as optical disks, hard disks, and high-capacity memories. The moving picture compression-encoding apparatuses include, not by way of limitation, digital video camcorders (DVCs) for storing digital video frames picked up by a camera and replaying the stored digital video frames, and private video recorders (PVRs).

When a record button is pushed, the moving picture compression-encoding apparatus starts recording and storing the moving picture. When a recording stop or pause signal is pushed, the moving picture compression-encoding apparatus stops or pauses recording. The moving picture data from the time when the record button is pushed to the time when the recording stop button is pushed is stored as a single file.

FIG. 1 is a view showing a data structure of an MPEG bit stream generated by a conventional MPEG encoder built in a moving picture compression-encoding apparatus. FIG. 2 is a view showing inputting, encoding, storing, and replaying orders of video frames in a conventional moving picture storing/replaying method.

As shown in FIG. 1, the MPEG bit stream generated by the MPEG encoder includes GOPs (groups of pictures), that is, groups of compression-encoded video frames. At the front end of each GOP, there is a sequence header having information on a starting point of the GOP and other information.

Referring to FIG. 2, each GOP includes at least one intra (I) video frame, predictive (P) video frame, and bi-directionally predictive (B) video frame. The I video frame is encoded without reference to any other video frames. The P video frame is predictively encoded forwardly, that is, with reference to an earlier I or P video frame of the GOP. The B video frame is predictively encoded bi-directionally, that is, with reference to earlier and later I or P video frames of the GOP.

Since the I video frame is encoded without reference to any other video frames, the corresponding moving picture can be replayed from the I video frame itself. For the purpose of random access, each GOP should include at least one I video frame. As described above, the P video frame is predictively encoded with reference to an earlier I or P video frame of the GOP. Since the B video frame is predictively encoded with reference to earlier and later I or P video frames of the GOP, the B video frame cannot be replayed without the earlier and later I or P video frames.

In the MPEG encoder, the encoding order of the video frames is different from the inputting order thereof. More specifically, with respect to the encoding order in the MPEG encoder, a B video frame is skipped, later I or P video frame is encoded in advance, and then, the skipped B video frame is predictively encoded. For example, as shown in FIG. 2, video frames B₄ and B₅ are bi-directionally predictively encoded with reference to an earlier video frame P₀ and a later video frame P₁. Therefore, only after the video frame P₁ is input, the video frames B₄ and B₅ can be predictively encoded with reference to the video frame P₁.

The encoded video frames are stored in accordance with a predetermined storing order. The stored video frames are decoded in accordance with the original input order.

However, in a conventional method of storing moving picture data, video frames necessary to replay the moving picture may be not stored depending on a time when a recording stop or pause signal is pushed.

For example, it is assumed that the recording stop or pause signal is pushed after the video frame B₄ is input to the moving picture compression-encoding apparatus. Since the video frame P₁ necessary to compression-encode the video frame B₄ has not yet been input to the moving picture compression-encoding apparatus, the video frame B₄ cannot be compression-encoded and stored.

Therefore, there is a need for a method of effectively storing video frames necessary to replay a moving picture in a moving picture compression-encoding apparatus when a recording stop or pause signal is pushed.

### SUMMARY OF THE INVENTION

An aspect of the present invention provides a moving picture compression-encoding apparatus and a moving picture storage method of compression-encoding and storing predetermined video frames necessary to replay a moving picture at the time of receiving a recording stop or pause signal, capable of accurately replaying stored video frames.

According to an aspect of the present invention, there is provided a moving picture compression-encoding apparatus. The apparatus includes an encoder selecting predetermined to-be-stored video frames at a time of receiving a record stop or pause signal, encoding at least the selected video frames, and generating a bit stream, and a moving picture file generating unit generating a moving picture file including the selected video frames based on the bit stream output from the encoder.

In addition, the selected video frames may include a last video frame of a GOP to which a currently-encoded video frame belongs at the time of receiving the record stop or pause signal.

In addition, the selected video frames may include at least an I video frame in a next GOP in addition to all the video frames of a GOP to which a currently-encoded video frame belongs at the time of receiving the record stop or pause signal.

In addition, the selected video frames may include an earlier I video frame prior to a currently-input video frame at the time of receiving the record stop or pause signal.

In addition, the selected video frames may include an earlier P video frame prior to a currently-input video frame at the time of receiving the record stop or pause signal.

In addition, the moving picture file generating unit may generate the moving picture file by adding a header in accordance with a predetermined moving picture format to the bit stream output from the encoder.

In addition, the moving picture compression-encoding apparatus may further comprise a storage unit storing the moving picture file generated by the moving picture file generating unit.

According to another aspect of the present invention, there is provided a method of storing a moving picture in accordance with an MPEG compression scheme or similar schemes for encoding I, B, and P video frames of moving picture data. The method includes determining whether or not a record stop or pause signal is received during recording, selecting predetermined to-be-stored video frames, encoding at least the selected video frames, and generating a bit stream if the record stop or pause signal is received during recording, generating a moving picture file including the selected video frames based on the bit stream, and storing the moving picture file.

In addition, the selecting of the selected video frames may include selecting the last video frame of a GOP of a video frame being currently encoded.

In addition, the selecting of the selected video frames may include selecting at least an I video frame in a next GOP in addition to all the video frames of a GOP to which the currently-encoded video frame belongs.

In addition, the selecting of the selected video frames may include selecting video frames necessary to replay a currently-encoded video frame.

In addition, the video frames necessary to replay the currently-encoded video frame may include an I or P video frame.

In addition, the selecting of the selected video frames may include selecting earlier replay-able video frames prior to a currently-input video frame.

In addition, the earlier video frame may be an I or P video frame.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a data structure of an MPEG bit stream generated by a conventional MPEG encoder;

FIG. 2 is a view showing inputting, encoding, storing, and replaying orders of video frames in a conventional moving picture storing/replaying method;

FIG. 3 is a block diagram showing a moving picture compression-encoding apparatus according to an embodiment of the present invention;

FIGS. 4 to 8 are views explaining for video frames stored at the time of receiving a recording stop or pause signal in the moving picture compression-encoding apparatus and the moving picture storage method according to embodiments of the present invention;

FIG. 9 is a flowchart showing a moving picture storage method according to a first embodiment of the present invention;

FIG. 10 is a flowchart showing a moving picture storage method according to a second embodiment of the present invention;

FIG. 11 is a flowchart showing a moving picture storage method according to a third embodiment of the present invention; and

FIG. 12 is a flowchart showing a moving picture storage method according to a fourth embodiment of the present invention.

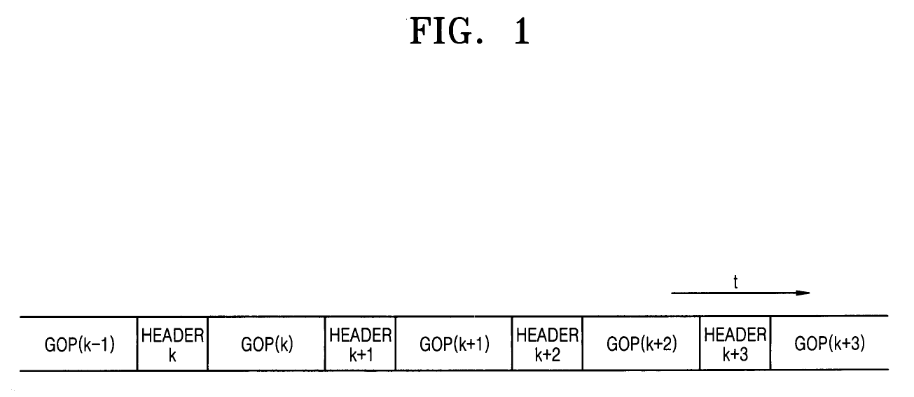

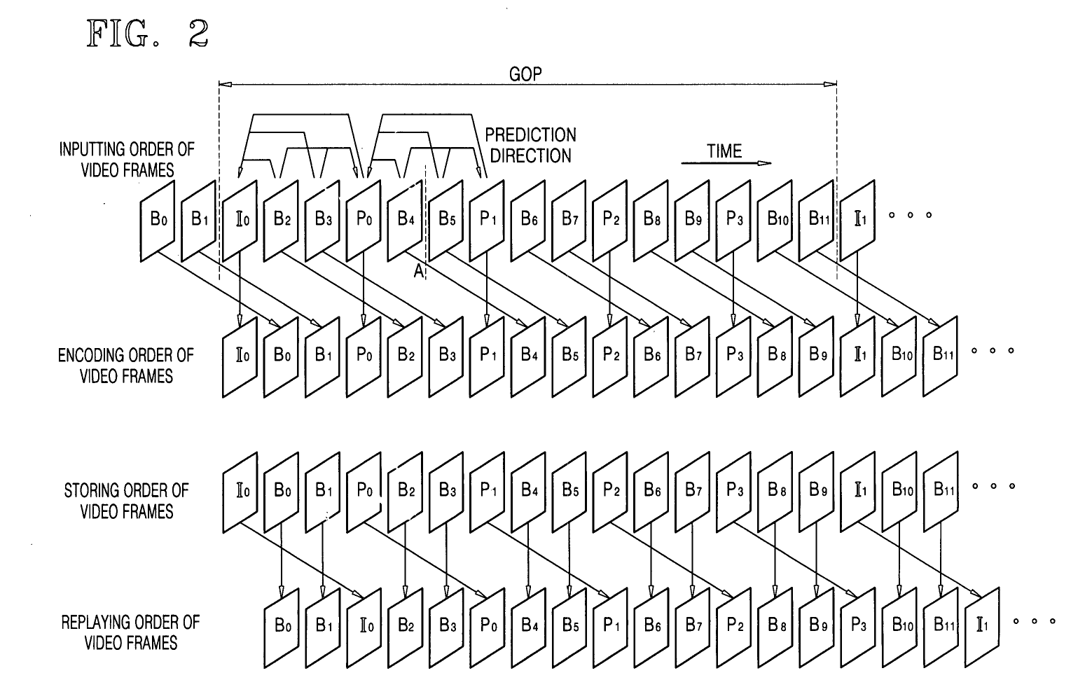

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

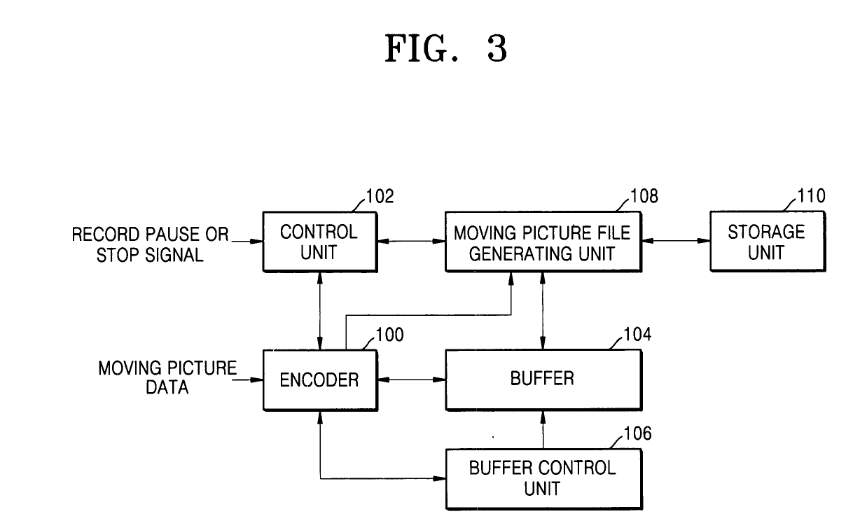

FIG. 3 is a block diagram showing a moving picture compression-encoding apparatus according to an embodiment of the present invention.

The moving picture compression-encoding apparatus includes an encoder 100, a control unit 102, a buffer 104, a buffer control unit 106, a moving picture file generating unit 108, and a storage unit 110.

The control unit 102 controls components of the moving picture compression-encoding apparatus. In particular, the control unit 102 detects record, recording stop or pause signals generated when a record, recording stop or pause button is pushed, respectively, and outputs the signals to the encoder 100.

In response to the record signal output from the control unit 102, the encoder 100 encodes input moving picture data in accordance with a moving picture compression-encoding standard such as MPEG-1/2/4 or H.264. More specifically, the encoder 100 performs discrete cosine transformation on the input moving picture data, quantizes the discret-consine-transformed moving picture data, performs motion estimation among video frames of the moving picture data, and performs variable length coding, thereby generating a compression-encoded bit stream.

On the other hand, when the recording stop or pause button is pushed, the encoder 100 selects predetermined to-be-stored video frames depending on the time of pushing the buttons and determines whether or not the predetermined to-be-stored video frames are encoded. If the encoding of the predetermined to-be-stored video frames is not completed, the encoder 100 continues encoding. If the encoding of the predetermined to-be-stored video frames is completed, the encoder 100 outputs information on the predetermined to-be-stored video frames to the moving picture file generating unit 108.

The buffer 104 temporarily buffers the video frames input to the encoder 100 and the bit stream output from the encoder 100.

The buffer control unit 106 controls the buffer 104 to buffer the video frames input to the encoder 100 and the bit stream output from the encoder 100. In addition, the buffer control unit 106 controls the buffer 104 to output the buffered bit stream to the moving picture file generating unit 108 in order to store the moving picture data.

The moving picture file generating unit 108 adds additional information to the bit stream to generate a moving picture file. For example, the additional information may include a header in accordance with the MPEG-4 or AVI format in order to generate a corresponding mp4 or avi moving picture file. The moving picture file is stored in the storage unit 110.

The term storage unit 110 may include, for example, optical disks, hard disks, high capacity memories, and others.

Now, operations of storing the moving picture data in the moving picture compression-encoding apparatus according the present invention will be described in detail.

When the record button is pushed, the moving picture data input into the moving picture compression-encoding apparatus is compression-encoded by the encoder 100 to generate the bit stream. Before input into the encoder 100, the moving picture data is temporarily buffered in the buffer 104. The buffered moving picture data is read out by the encoder 100 at a predetermined time.

The bit stream output from the encoder 100 is temporarily buffered in the buffer 104 under the control of the buffer control unit 106.

The buffered bit stream is read out by the moving picture file generating unit 108 to generate the moving picture file by adding the additional information such as a header to the bit stream. The moving picture file is stored in the storage unit 110.

During the recording procedure described above, if the recording stop or pause button is pushed, the control unit 102 detects and outputs the recording stop or pause signal to the encoder 100.

In response to the recording stop or pause signal, the encoder 100 determines whether or not the predetermined to-be-stored video frames are encoded.

If the predetermined to-be-stored video frames are encoded, the encoder 100 outputs information on the predetermined to-be-stored video frames to the moving picture file generating unit 108.

More specifically, in response to the recording stop or pause signal, the encoder 100 may select one of the following 4 exemplary cases of the predetermined to-be-stored video frames.

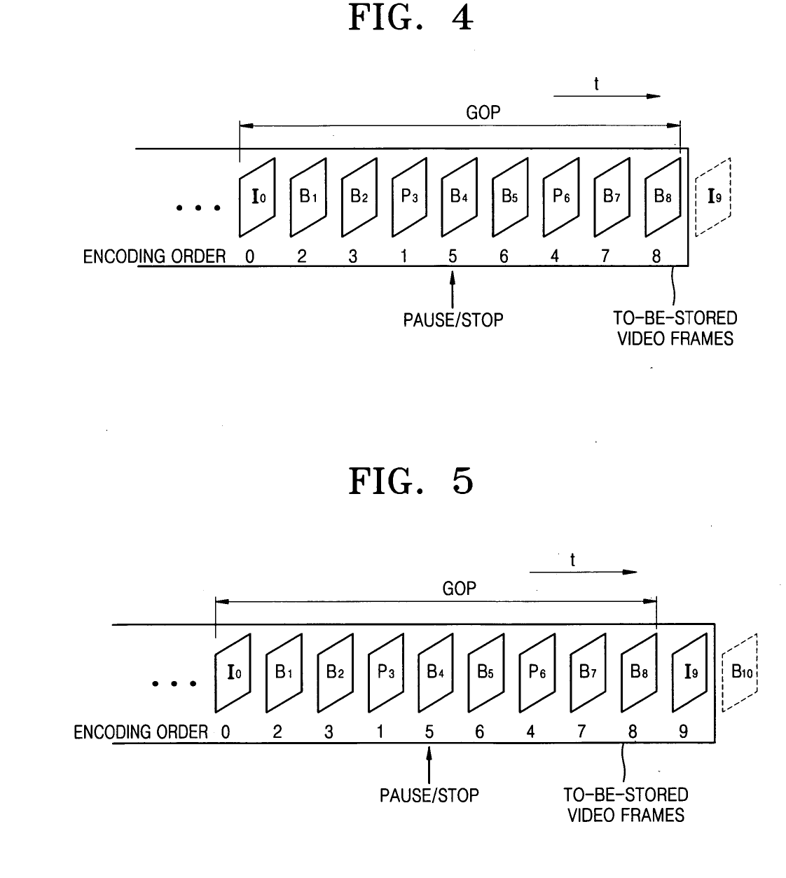

Now, four exemplary cases of the predetermined to-be-stored video frames at the recording stop or pause time in the moving picture compression-encoding apparatus according to an embodiment of the present invention will be described in detail with reference to FIG. 4 to FIG. 8.

(First Case)

In the first case, encoding and storing are performed on all the video frames (including the last video frame) of a group of pictures (GOP) to which the currently-encoded video frame belongs at the time of receiving the recording stop or pause signal. In this case, the moving picture data can be stored in units of a GOP irrespective of the time when the recording stop or pause button is pushed.

For example, as shown in FIG. 4, it is assumed that the GOP consists of 9 video frames I₀, B₁, B₂, P₃, B₄, B₄, B₅, P₆, B₇, and B₈, and the encoder 100 is encoding a video frame B₄ at the time of receiving the recording stop or pause signal. In this case, the encoder 100 further reads out and encodes the following video frames B₅, P₆, B₇, and B₈. Here, the video frames B₇ and B₈ are bi-directionally predictively-encoded with reference to not the video frame I₉ in the next GOP but the earlier video frames P₃ and P₆ in the current GOP, so that an independent GOP can be constructed. The encoder 100 generates a bit stream and outputs information on the video frames I₀, B₁, B₂, P₃, B₄, B₄, B₅, P₆, B₇, and B₈ to the moving picture file generating unit 108.

(Second Case)

In the second case, encoding and storing are performed on at least one I video frame in the next GOP in addition to all the video frames of the current GOP to which the currently-encoded video frame belongs at the time of receiving the recording stop or pause signal.

For example, as shown in FIG. 5, it is assumed that the GOP consists of 9 video frames I₀, B₁, B₂, P₃, B₄, B₄, B₅, P₆, B₇, and B₈, and the encoder 100 is encoding a video frame B₄ at the time of receiving the recording stop or pause signal. In this case, the encoder 100 further reads out and encodes the following B₅, P₆, B₇, B₈, and B₉ in the current GOP and the video frame I₉ in the next GOP. The encoder 100 generates a bit stream and outputs information on the video frames I₀, B₁, B₂, P₃, B₄, B₄, B₅, P₆, B₇, B₈ and I₉, to the moving picture file generating unit 108.

In this case, since the I video frame in the next GOP is also encoded, the moving picture storage method in this case is useful for the so-called trick play used for a high speed replaying of the moving picture.

(Third Case)

In the third case, encoding and storing are performed on video frames of the current GOP necessary to replay the currently-encoded video frame at the time of receiving the recording stop or pause signal.

Unlike the first case where all the video frames of the GOP to which the currently-encoded video frame belongs at the time receiving the recording stop or pause signal are encoded, all the video frames of the current GOP are not necessarily encoded in the third case.

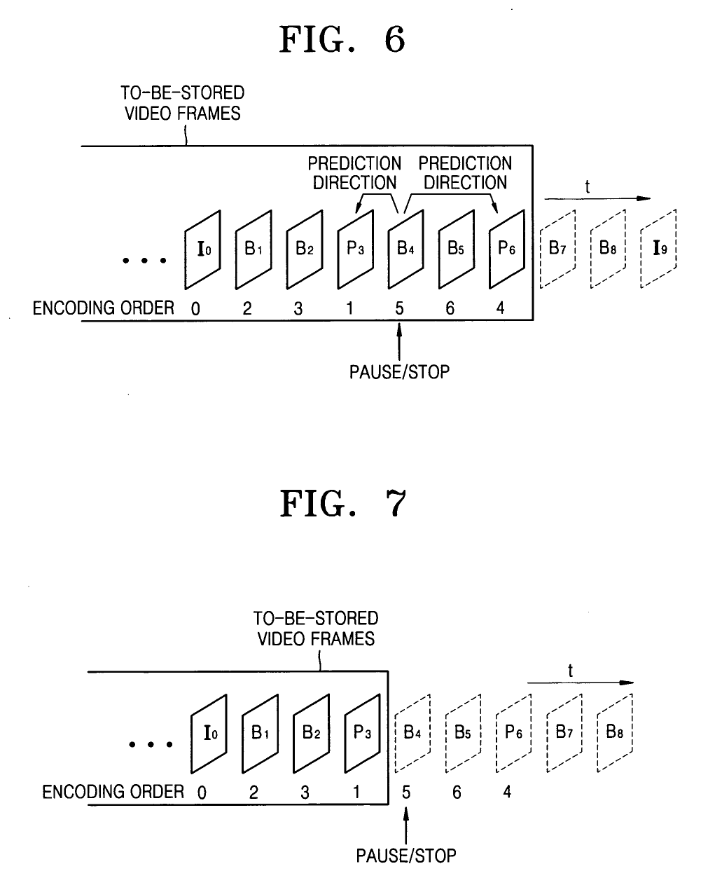

For example, as shown in FIG. 6, it is assumed that the GOP consists of 9 video frames I₀, B₁, B₂, P₃, B₄, B₅, P₆, B₇, and B₈, and the encoder 100 is encoding a video frame B₄ at the time of receiving the recording stop or pause signal. In this case, the encoder 100 encodes only the video frames I₀, B₁, B₂, P₃, B₄, B₅ and P₆, necessary to replay the bi-directional predictive video frame B₄. As described above, in the first case, all the video frames I₀, B₁, B₂, P₃, B₄, B₅, P₆, B₇, B₈ are encoded. The encoder 100 generates a bit stream and outputs information on the video frames I₀, B₁, B₂, P₃, B₄, B₅ and P₆ to the moving picture file generating unit 108. As indicated, the third case is different from the first case in that only the video frames to replay the currently-encoded video frame at the time of receiving the recording stop or pause signal are encoded.

(Fourth Case)

In the fourth case, encoding and storing are performed on an earlier I or P video frame prior to the currently-input video frame at the time of receiving the recording stop or pause signal.

In this case, the difference between a desired time of stopping or pausing recording and the real time when the recording stop or pause button is pushed is taken into consideration.

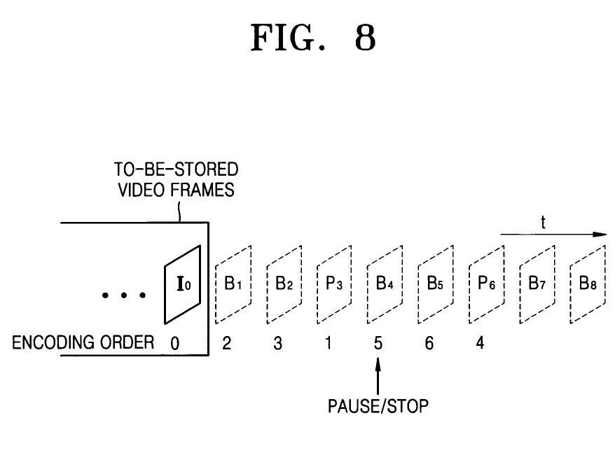

For example, shown in FIG. 7, it is assumed that the GOP consists of 9 video frames I₀, B₁, B₂, P₃, B₄, B₅, P₆, B₇, and B₈, and the encoder 100 is encoding a video frame B₄ at the time of receiving the recording stop or pause signal. In this case, the encoder 100 determines whether or not the video frame P₃, that is, the earlier I or P video frame prior to the video frame B₄ is encoded. If the video frame P₃ is encoded, the encoder 100 generates a bit stream and outputs information on the video frames I₀, B₁, B₂, and P₃ to the moving picture file generating unit 108 to store only the video frames I₀, B₁, B₂, and P₃.

As shown in FIG. 8, if the video frame P₃ is not encoded, the encoder 100 determines whether or not the video frame I₀, that is, another earlier I or P video frame prior to the video frame B4 is encoded. If the video frame I₀ is encoded, the encoder 100 generates a bit stream and outputs information on the video frame I₀ to the moving picture file generating unit 108 to store only the video frame I₀.

As described with reference to the four cases, at the time of the record stop or pause signal, the encoder 100 encodes predetermined to-be-stored video frames, generates a bit stream, and outputs information on the predetermined to-be-stored video frames to the moving picture file generating unit 108. The bit stream output from the encoder 100 is temporarily buffered in the buffer 104. The moving picture file generating unit 108 reads out the bit stream from the buffer 104 based on the information output from the encoder 100 to generate the moving picture file. The moving picture file is stored in the storage unit 110.

Now, moving picture storage methods according to the present invention performed in the moving picture compression-encoding apparatus will be described.

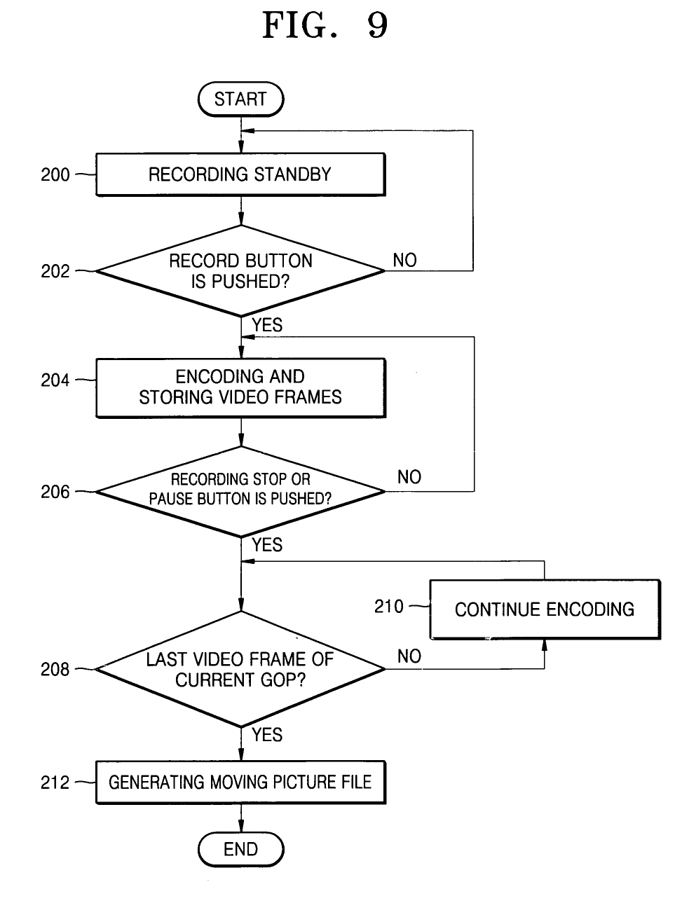

FIG. 9 is a flowchart showing a moving picture storage method according to a first embodiment of the present invention;

In the moving picture storage method according to the first embodiment, when the moving picture compression-encoding apparatus is in a standby state (200), a control unit 102 determines whether or not the recoding button is pushed (202). If the recording button is not determined to be pushed, the moving picture compression-encoding apparatus maintains the standby state.

If the recording button is determined to be pushed, the control unit 102 outputs a recording signal to an encoder 100. The encoder 100 encodes input video frames and generates a bit stream. The bit stream is buffered in a buffer 104. A moving picture file generating unit 108 reads out the buffered bit stream from the buffer 104 and generates a predetermined-format moving picture file. The moving picture file is stored in a storage unit 110 (204).

The control unit 102 determines whether or not a record stop or pause button is pushed during recording (206). If the record stop or pause button is pushed, the control unit 102 outputs a record stop or pause signal to the encoder 100. In response to the record stop or pause signal, the encoder 100 determines whether or not the currently-encoded video frame is the last video frame in the current GOP (208).

If the currently-encoded video frame is not the last video frame in the current GOP, the encoder 100 continues encoding the next video frame (210). Next, the encoder 100 determines whether or not the next encoded video frame is the last video frame in the current GOP (208).

If the last video frame in the current GOP is encoded in the encoder 100 at the time of receiving the recording stop or pause signal, the encoder 100 generates a bit stream and outputs information on the video frames to the moving picture file generating unit 108. A moving picture file generating unit 108 reads out the bit stream and generates a predetermined-format moving picture file (212). The moving picture file is stored in a storage unit 110. As a result, recording is completed.

Returning to FIG. 4, in a case where a video frame B₄ is input to the encoder 100 when a recording stop or pause button is pushed, the encoder 100 determines whether or not the currently-encoded video frame is the last video frame in the current GOP. In FIG. 4, since the video frame B₄ is not the last video frame B₈ in the current GOP, the encoder 100 continues encoding until the last video frame B₈ is input.

When the encoder 100 encodes the last video frame B₈, the encoder 100 generates the bit stream and outputs the bit stream to the moving picture file generating unit 108. The moving picture file generating unit 108 reads out the bit stream and generates a predetermined-format moving picture file. The moving picture file is stored in a storage unit 110.

In summary, in the moving picture storage method according to the first embodiment of the present invention, when the recording stop or pause signal is pushed, if the currently-encoded video frame is the last video frame in the current GOP, the encoder 100 completes encoding; and if not, the encoder continues encoding until the last video frame of the current GOP is input and encoded. As a result, the moving picture data can be stored in units of GOPs.

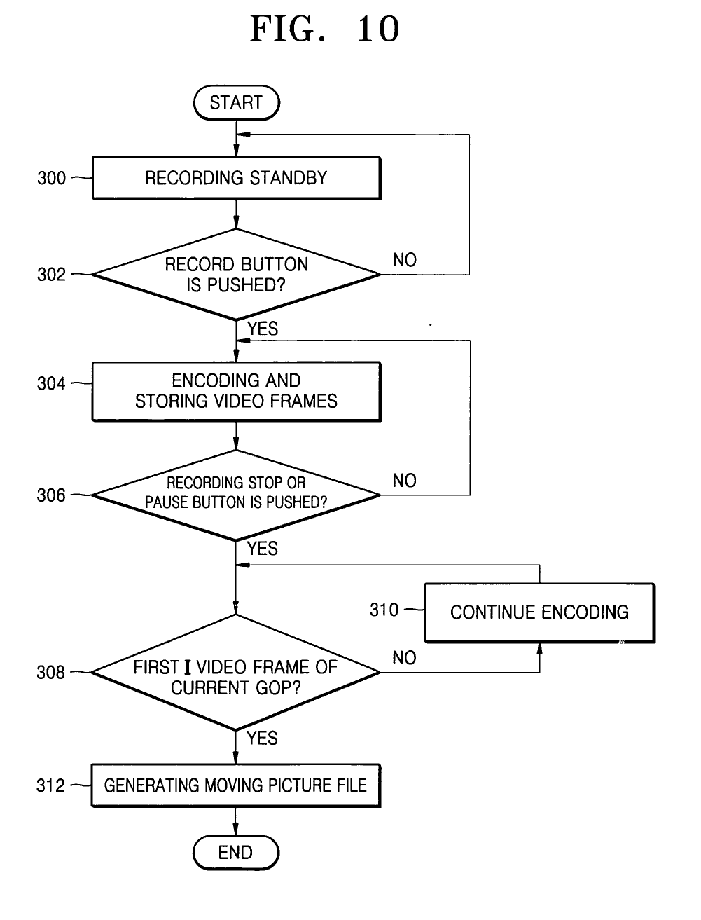

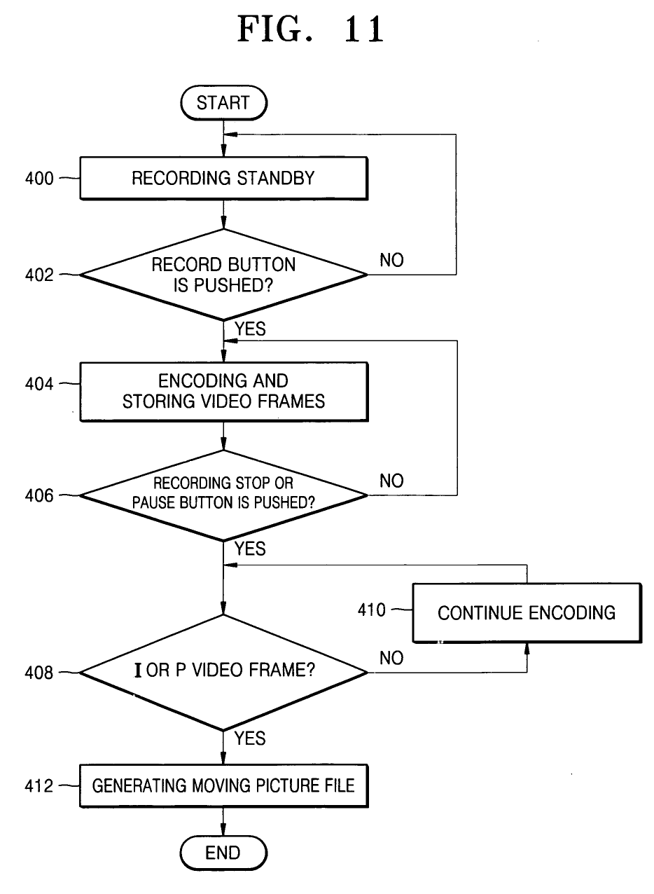

FIG. 10 is a flowchart showing a moving picture storage method according to a second embodiment of the present invention.

In the moving picture storage method according to the second embodiment, encoding and storing are performed on the I video frame of the next GOP unlike the moving picture storage method according to the first embodiment where encoding and storing are performed on the last video frame of the current GOP.

Referring to FIG. 10, operations from operation 300 of maintaining a standby state to operation 306 of determining whether or not a recording stop or pause signal is pushed are the same as those of the first embodiment.

However, as described above, in the moving picture storage method according to the second embodiment, encoding is performed on the first video frame of the next GOP, that is, the I video frame of the next GOP in addition to the last video frame of the current GOP (operations 308-310) unlike the moving picture storage method according to the first embodiment where encoding is performed on the last video frame of the current GOP. The following operations are the same as those of the first embodiment. That is, the encoder 100 generates the bit stream and outputs the bit stream to the moving picture file generating unit 108. The moving picture file generating unit 108 reads out the bit stream and generates a predetermined-format moving picture file. The moving picture file is stored in a storage unit 110 (312).

Returning to FIG. 5, in a case where a video frame B4 is input to the encoder 100 when a recording stop or pause button is pushed, the encoder 100 encodes the first video frame I₉ of the next GOP in addition to the last video frame B₈ of the current GOP. Next, the encoder 100 generates the bit stream including the first video frame I₉ of the next GOP and outputs the bit stream to the moving picture file generating unit 108. The moving picture file generating unit 108 reads out the bit stream and generates a predetermined-format moving picture file. The moving picture file is stored in a storage unit 110.

The moving picture storage method according to the second embodiment of the present invention is used for the so-called trick play for extracting only the I video frames from a compression-encoded moving picture file to decode and replay. The trick play is used to search the compression-encoded bit streams forwards and backwards at a high speed of 2×, 4×, 32×, or the like. The trick play is similar to the FF (fast-forward) and REW (rewind) functions of a VCR.

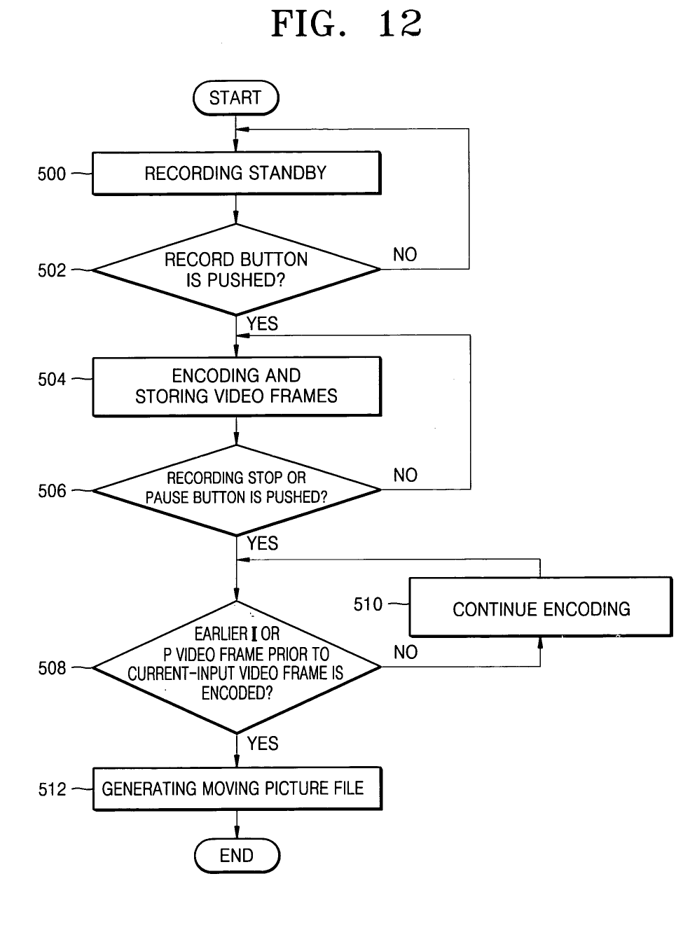

FIG. 11 is a flowchart showing a moving picture storage method according to a third embodiment of the present invention.

In the moving picture storage method according to the third embodiment, encoding and storing are performed on video frames necessary to replay the currently-encoded video frame at the time of receiving the recording stop or pause signal. More specifically, at the time of receiving the recording stop or pause signal, if the currently-encoded video frame is not the I or P video frame, the encoder 100 continues encoding until the I or P video frame is input. After the I or P video frame is encoded and stored, recording is completed.

Referring to FIG. 11, operations from operation 400 of maintaining a standby state to operation 406 of determining whether or not a recording stop or pause signal is pushed are the same as those of the first and second embodiments. Therefore, description of the same components and operations of the third embodiment as those of the first and second embodiments will be omitted. When the record stop or pause button is pushed during recording, a control unit 102 outputs a record stop or pause signal to an encoder 100. When the encoder 100 receives the record stop or pause signal, the encoder 100 determines whether or not a moving picture can be replayed based on the currently-encoded video frames.

As described above, the I video frame is encoded without reference to any other video frames; the P video frame is predictively encoded with reference to an earlier I or P video frame; and B video frame is predictively encoded bi-directionally with reference to earlier and later I or P video frames. Therefore, the encoder 100 determines whether or not the currently-encoded video frame is an I or P video frames (408).

If the currently-encoded video frame is not an I or P video frame, the encoder 100 continues encoding until the next I or P video frame is input (410).

When the next I or P video frame is encoded, the encoder 100 generates the bit stream and outputs the bit stream to the moving picture file generating unit 108. The moving picture file generating unit 108 reads out the bit stream and generates a predetermined-format moving picture file. The moving picture file is stored in a storage unit 110 (412).

Returning to FIG. 6, in a case where a video frame B4 is input to the encoder 100 when a recording stop or pause button is pushed, if the encoding ends, a moving picture associated with the encoded video frame B₄ cannot be accurately replayed. That is because a later video frame P₆ as well as an earlier video frame P₃ is needed to replay the video frame B₄.

Therefore, when the recording stop or pause button is pushed, the encoder 100 continues encoding until the video frame P₆ necessary to replay the video frame B₄ is input. Next, the encoder 100 generates the bit stream and outputs the bit stream to the moving picture file generating unit 108. The moving picture file generating unit 108 reads out the bit stream and generates a predetermined-format moving picture file. The moving picture file is stored in a storage unit 110. Therefore, the video frame B₄ can be replayed with motion compensation with reference to the video frame P₆.

FIG. 12 is a flowchart showing a moving picture storage method according to a fourth embodiment of the present invention. Here, description of the same components and operations 500 to 506 of the fourth embodiment as those of the first to third embodiments will be omitted.

In the moving picture storage method according to the fourth embodiment, encoding and storing are performed on earlier replay-able video frames prior to the currently-input video frame at the time of receiving the recording stop or pause signal. That is, the encoding and storing are performed on earlier I or P video frame prior to the currently-input video frame. In the fourth embodiment, the difference between a desired time of stopping or pausing recording and the real time when the recording stop or pause button is pushed is taken into consideration.

Referring to FIG. 12, when the record stop or pause signal is pushed, the encoder 100 determines whether or not is an earlier I or P video frame prior to the currently-input video frame is encoded (508).

If the earlier I or P video frame prior to the currently-input video frame is not encoded, the encoder 100 continues encoding until the I or P video frame is encoded (510).

If the earlier I or P video frame prior to the currently-input video frame is encoded, the encoder 100 generates the bit stream and outputs the bit stream to the moving picture file generating unit 108. The moving picture file generating unit 108 reads out the bit stream and generates a predetermined-format moving picture file. The moving picture file is stored in a storage unit 110 (512).

Returning to FIG. 7, in a case where a video frame B4 is input to the encoder 100 when a recording stop or pause button is pushed, the encoder 100 determines whether or not the earlier video frame P₃ prior to the video frame B₄ is encoded. If the earlier video frame P₃ is not encoded but buffered in the buffer 104, the encoder 100 continues encoding until the video frame P₃ is encoded.

After the encoder 100 encodes the video frame P₃, the encoder 100 generates the bit stream, buffers the bit stream in the buffer 104, and output the bit stream to the moving picture file generating unit 108. The moving picture file generating unit 108 reads out the bit stream including the video frame P₃ and generates a predetermined-format moving picture file. The moving picture file is stored in a storage unit 110.

Returning to FIG. 8, similar to the case of FIG. 7, in a case where a video frame B₄ is input into the encoder 100 when a recording stop or pause button is pushed, the encoder 100 determines whether or not the earlier video frame I₀ prior to the video frame B₄ is encoded. If the earlier video frame I₀ is encoded, the encoder 100 generates the bit stream, buffers the bit stream in the buffer 104, and output the bit stream to the moving picture file generating unit 108. The moving picture file generating unit 108 reads out the bit stream including the video frame P₃ and generates a predetermined-format moving picture file. The moving picture file is stored in a storage unit 110.

According to an embodiment of a moving picture compression-encoding apparatus and a moving picture storage method of the present invention, when a record stop or pause button is pushed, predetermined video frames necessary to replay a moving picture are compression-encoded and stored, so that it is possible to effectively replay the moving picture. Particularly, in a moving picture compression-encoding apparatus such as a digital video camcorder (DVC) and a private video recorder (PVR) to which the moving picture storage method of the present invention is adapted, an effective high-speed search is available and moving picture data can be stored and replayed without loss of data.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A moving picture compression-encoding apparatus comprising:
an encoder selecting predetermined to-be-stored video frames at a time of receiving a record stop or pause signal, encoding at least the selected video frames, and generating a bit stream; and
a moving picture file generating unit generating a moving picture file including the selected video frames based on the bit stream output from the encoder.

2. The moving picture compression-encoding apparatus according to claim 1, wherein the selected video frames include a last video frame of a GOP to which a currently-encoded video frame belongs at the time of receiving the record stop or pause signal.

3. The moving picture compression-encoding apparatus according to claim 1, wherein the selected video frames include at least an I video frame in a next GOP in addition to all video frames of a GOP to which a currently-encoded video frame belongs at the time of receiving the record stop or pause signal.

4. The moving picture compression-encoding apparatus according to claim 1, wherein the selected video frames include an earlier I video frame prior to a currently-input video frame at the time of receiving the record stop or pause signal.

5. The moving picture compression-encoding apparatus according to claim 1, wherein the selected video frames include an earlier P video frame prior to a currently-input video frame at the time of receiving the record stop or pause signal.

6. The moving picture compression-encoding apparatus according to claim 1, wherein the moving picture file generating unit generates the moving picture file by adding a header in accordance with a predetermined moving picture format to the bit stream output from the encoder.

7. The moving picture compression-encoding apparatus according to claim 1, further comprising a storage unit storing the moving picture file generated by the moving picture file generating unit.

8. A method of storing a moving picture in accordance with an MPEG compression scheme or similar schemes for encoding I, B, and P video frames of moving picture data, comprising:
determining whether or not a record stop or pause signal is received during recording;
selecting predetermined to-be-stored video frames, encoding at least the selected video frames, and generating a bit stream if the record stop or pause signal is received during recording;
generating a moving picture file including the selected video frames based on the bit stream; and
storing the moving picture file.

9. The method according to claim 8, wherein the selecting of the selected video frames includes selecting a last video frame of a GOP of a video frame being currently encoded.

10. The method according to claim 8, wherein the selecting of the selected video frames includes selecting at least an I video frame in a next GOP in addition to all the video frames of a GOP to which a currently-encoded video frame belongs.

11. The method according to claim 8, wherein the selecting of the selected video frames includes selecting video frames necessary to replay a currently-encoded video frame.

12. The method according to claim 11, wherein the video frames necessary to replay the currently-encoded video frame include an I or P video frame.

13. The method according to claim 8, wherein the selecting of the selected video frames includes selecting earlier replay-able video frames prior to a currently-input video frame.

14. The method according to claim 13, wherein the earlier video frame is an I or P video frame.

15. A method comprising:
designating a particular frame in a series of frames to be a last recorded frame; and
buffering at least one additional frame later in the series of frames to be used in creating or storing the particular frame designated as the last recorded frame.

16. The method according to claim 15, wherein the designating comprises:
receiving a recording stop signal.

17. The method according to claim 15, wherein the designating comprises:
receiving a recording pause signal.

18. The method according to claim 15, wherein the buffering comprises:
receiving at least one individually encoded video frame to be used in creating or storing the particular frame designated as the last recorded frame.

19. The method according to claim 15, wherein the buffering comprises receiving at least one forward predictively encoded video frame to be used in creating or storing the particular frame designated as the last recorded frame.

20. The method according to claim 20, wherein the series of frames comprises a Group of Pictures (GOP).
